(19) United States
(12) Patent Application Publication
(10) Pub. No.: US 2022/0382876 A1
(43) Pub. Date: Dec. 1, 2022

(54) SECURITY VULNERABILITY MANAGEMENT

(71) Applicant: INTERNATIONAL BUSINESS MACHINES CORPORATION, ARMONK, NY (US)

(72) Inventors: Sai ZENG, Yorktown Heights, NY (US); Jinho HWANG, Dobbs Ferry, NY (US); Virginia Mayo Policarpio, Jersey City, NJ (US); Lisa M. Chambers, TUCSON, AZ (US); Constantin Mircea Adam, Fairfield, CT (US); Muhammed Fatih Bulut, West Greenwich, RI (US)

(21) Appl. No.: 17/329,448

(22) Filed: May 25, 2021

(51) Int. Cl. G06F 21/57

(52) U.S. Cl. CPC G06F 21/577; G06F 2221/034

(57) ABSTRACT

A vulnerability management method includes analyzing a system environment to uncover one or more vulnerabilities. The method includes subsequently identifying one or more system weaknesses corresponding to the one or more uncovered vulnerabilities and analyzing a set of historical data to identify similar past vulnerabilities. The method further includes analyzing available information to extract one or more impacts of the identified similar past vulnerabilities and determining one or more impacts to the present system environment that would correspond to the extracted one or more impacts of the identified similar past vulnerabilities. The method additionally includes recommending one or more actions to remediate the uncovered vulnerabilities.

### BACKGROUND

The present invention relates generally to the field of cyber security, and more specifically, to managing vulnerabilities according to historical data.

The number of cyber attacks has grown steadily in recent years. Some metrics indicate that a cyber attack is launched nearly every 40 seconds according to recent data, and the numbers swell each year. Cyber attacks come in many different forms, from those directed towards individual's personal information to confidential industrial product data. With such varied targets, the consequences of a cyber attack can also vary greatly, from impersonation or fraudulent individual data use to less individualized impact such as widespread power cuts.

### SUMMARY

As disclosed herein, a vulnerability management method includes analyzing a system environment to uncover one or more vulnerabilities, identifying one or more system weaknesses corresponding to the one or more uncovered vulnerabilities, analyzing a set of historical data to identify similar past vulnerabilities, analyzing available information to extract one or more impacts of the identified similar past vulnerabilities, determining one or more impacts to the present system environment that would correspond to the extracted one or more impacts of the identified similar past vulnerabilities, and recommending one or more actions to remediate the uncovered vulnerabilities. A computer program product and computer system corresponding to the method are also disclosed.

### BRIEF DESCRIPTION OF THE DRAWINGS

FIG. 1 is a block diagram depicting a vulnerability management system in accordance with at least one embodiment of the present invention;

FIG. 2 is a flowchart depicting a vulnerability management method in accordance with at least one embodiment of the present invention;

FIG. 3 is a flowchart depicting a vulnerability correlation method in accordance with at least one embodiment of the present invention;

FIGS. 4A-4C depict node patterns corresponding to results exhibiting contextual relevance between vulnerabilities and real world evidences in accordance with at least one embodiment of the present invention;

FIG. 5 depicts a vulnerability score breakdown in accordance with one embodiment of the present invention; and

FIG. 6 is a block diagram of components of a computing system in accordance with an embodiment of the present invention.

### DETAILED DESCRIPTION

With respect to modern computing environments, maintaining a secure systems landscape is an increasingly difficult proposition thanks to the prevalence and variety of cyber attack attempts. Recent data indicates that nearly all exploited vulnerabilities in systems have been known for at least a year's time; in other words, it is rare that a cyber attack is able to breach a system through a previously unknown vulnerability. The present invention seeks to greatly alleviate the number of cyber attacks via known vulnerabilities by leveraging available data to proactively fortify these vulnerabilities and defend against corresponding cyber attacks. It should be appreciated that, as used herein, the term “weakness” refers generally to an error in code or elsewhere in a system, while the term “vulnerability” refers to a weakness in a software or system that can be exploited by an attacker. Software weaknesses include flaws, faults, bugs, vulnerabilities, and other errors in software code, design, architecture, or implementation that, if left untreated, could result in systems and networks being vulnerable to attacks. Examples of software weaknesses include, but are not limited to, buffer overflows, format strings, structure and validity problems, common special element manipulations, channel and path errors, handler errors, user interface errors, pathname traversal and equivalence errors, authentication errors, resource management errors, insufficient verification of data, code evaluation and injection, and randomness and predictability.

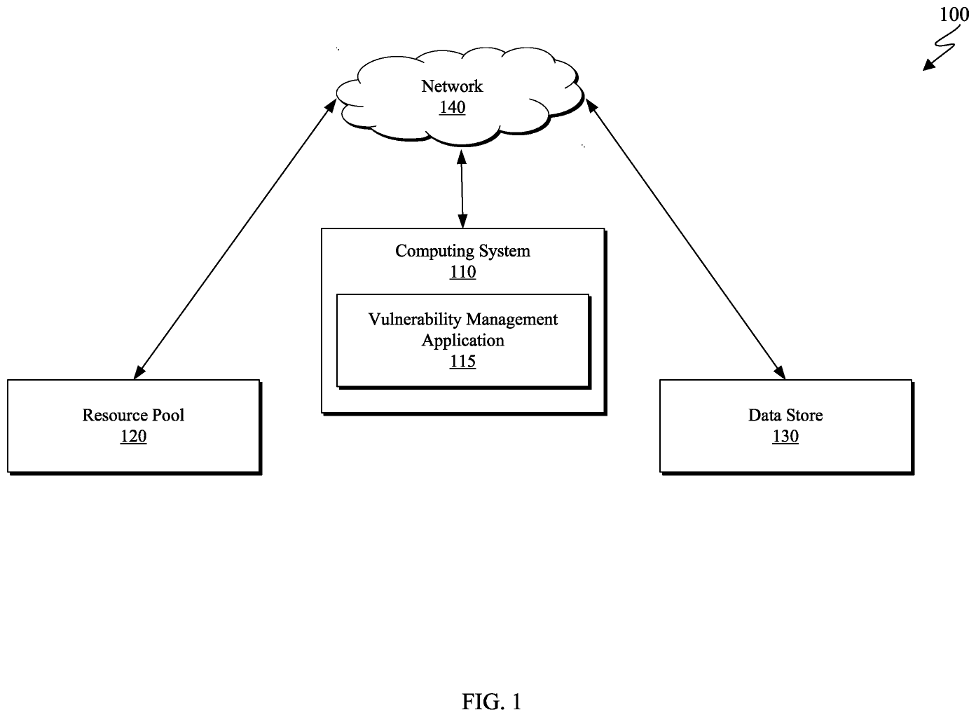

FIG. 1 is a block diagram depicting a vulnerability management system 100 in accordance with at least one embodiment of the present invention. As depicted, vulnerability management system 100 includes computing system 110, resource pool 120, data store 130, and network 140. Vulnerability management system 100 may enable identification and mitigation of vulnerabilities and weaknesses within a computing environment. It should be appreciated that vulnerability management system 100 corresponds to one of many arrangements of resources which may be suitable for such a system; for example, while the depicted embodiment has all elements independently located, additional embodiments may exist where any of computing system 110, resource pool 120, and data store 130 are collocated.

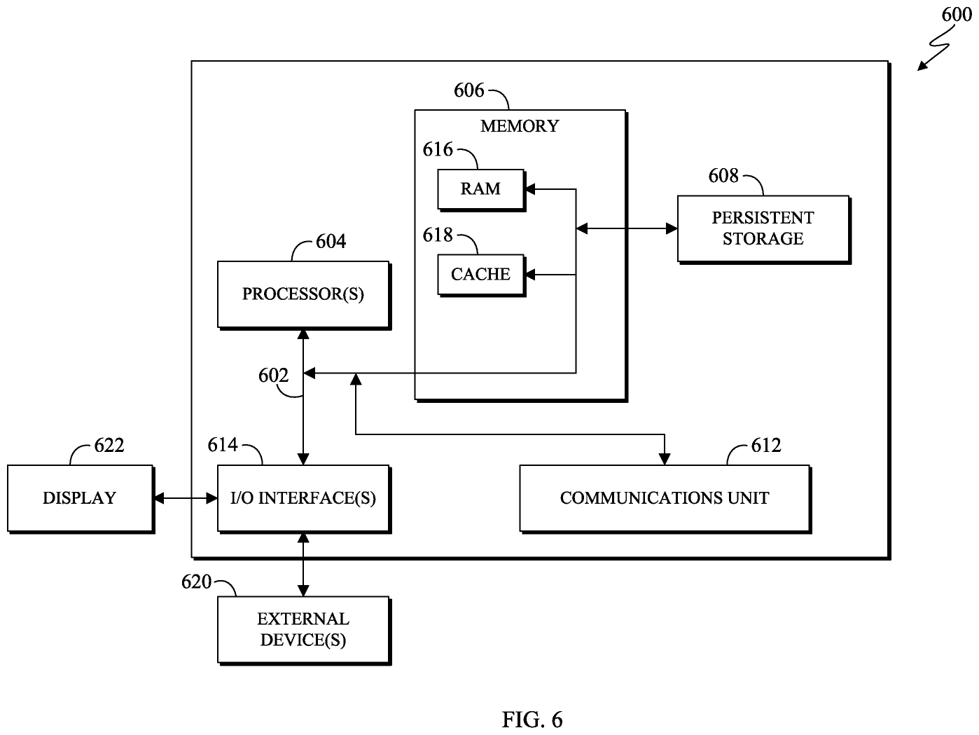

Computing system 110 can be a desktop computer, a laptop computer, a specialized computer server, or any other computer system known in the art. In some embodiments, computing system 110 represents computer systems utilizing clustered computers to act as a single pool of seamless resources. In general, computing system 110 is representative of any electronic device, or combination of electronic devices, capable of receiving and transmitting data, as described in greater detail with regard to FIG. 6. Computing system 110 may include internal and external hardware components, as depicted and described in further detail with respect to FIG. 8.

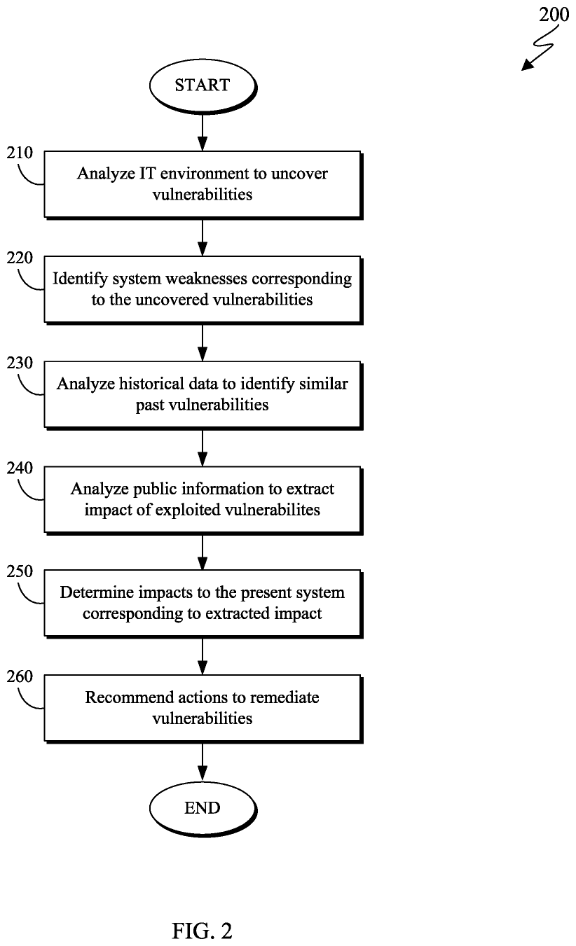

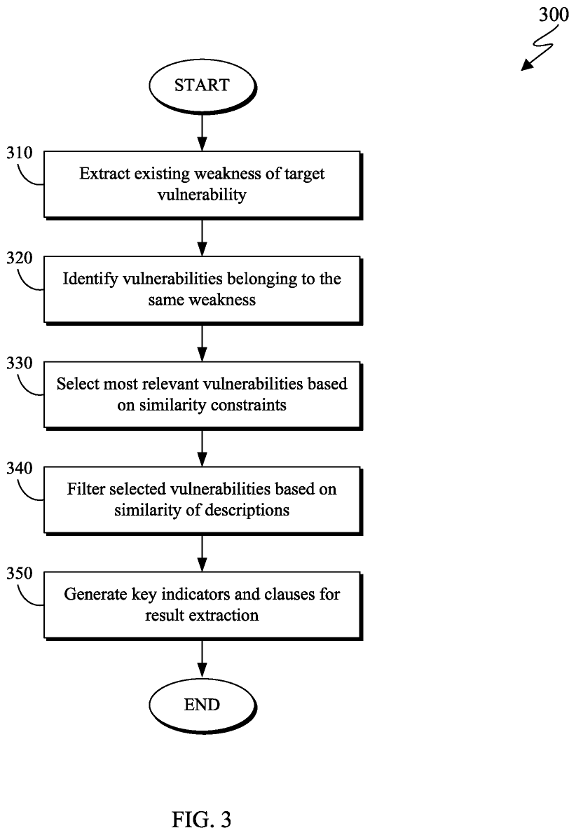

As depicted, computing system 110 includes vulnerability management application 115. Vulnerability management application 115 may be configured to analyze vulnerabilities and weaknesses with respect to any number of computing resources, such as resource pool 120. Vulnerability management application 115 may be configured to execute a vulnerability management method, such as vulnerability management method 200 described with respect to FIG. 2. Similarly, vulnerability management application 115 may be configured to execute a vulnerability correlation method such as vulnerability correlation method 300 described with respect to FIG. 3.

Data store 130 may be configured to store received information and can be representative of one or more databases that give permissioned access to computing system 110 or publicly available databases. In general, data store 130 can be implemented using any non-volatile storage media known in the art. For example, data store 130 can be implemented with a tape library, optical library, one or more independent hard disk drives, or multiple hard disk drives in a redundant array of independent disk (RAID).

Resource pool 120 refers generally to any combination of resources monitored by, or corresponding to, computing system 110 and vulnerability management application 115. It should be appreciated that resource pool 120, though depicted as a single entity, may correspond to a multitude of resources hosted in any number of systems and locations. In general, resource pool 120 corresponds to any resource(s) whose security is managed by vulnerability management application 115.

Network 140 can be, for example, a local area network (LAN), a wide area network (WAN) such as the Internet, or a combination of the two, and include wired, wireless, or fiber optics connections. In general, network 140 can be any combination of connections and protocols that will support communications between computing system 110, data store 130, and resource pool 120.

FIG. 2 is a flowchart depicting a vulnerability management method 200 in accordance with at least one embodiment of the present invention. As depicted, vulnerability management method 200 includes analyzing (210) a system environment to uncover vulnerabilities, identifying (220) system weaknesses corresponding to the uncovered vulnerabilities, analyzing (230) historical data to identify similar past vulnerabilities, analyzing (240) public information to extract one or more impacts of the identified similar past vulnerabilities, determining (250) one or more impacts to the present system environment that would correspond to the extracted one or more impacts of the identified similar past vulnerabilities, and recommending (260) actions to remediate the vulnerabilities.

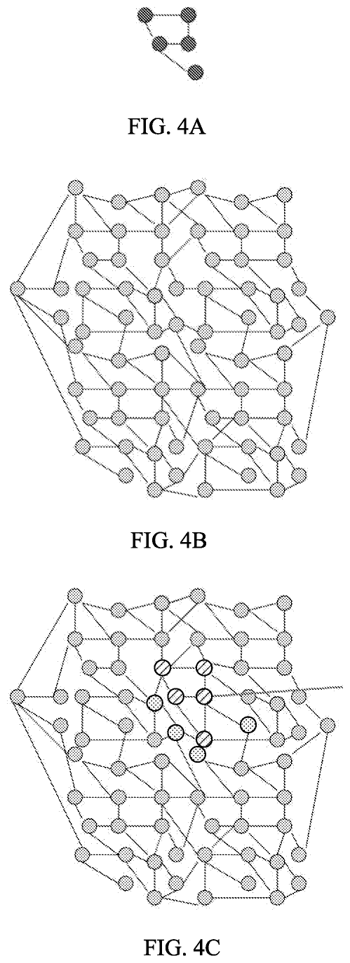

Analyzing (210) a computing environment to uncover vulnerabilities may include analyzing one or more systems within the computing environment to existing vulnerabilities. In at least one embodiment, analyzing (210) a computing environment includes executing security checks to verify components within the computing environment. Appropriate security checks may be configured to validate proper functioning of both hardware and software components within the environment. In at least some embodiments, analyzing (210) a computing environment includes analyzing available security reports to identify known vulnerabilities. Known vulnerabilities may correspond to vulnerabilities or components that have already been identified by a security check as problematic or improperly functioning. In at least one embodiment, analyzing (210) a computing environment additionally includes identifying any vulnerabilities in the environment which has been exposed in the past; for example, analyzing (210) a computing environment may include analyzing available records of past cyber attacks or security threats to identify vulnerabilities which have been previously exposed. One example of a vulnerability analysis is described in more detail with respect to FIG. 4.

Identifying (220) system weaknesses corresponding to the uncovered vulnerabilities may include identifying errors or imperfections within system hardware or software which may correspond to the uncovered vulnerabilities. For example, with respect to the embodiments in which vulnerabilities have been identified relative to previous security breaches, identifying (220) system weaknesses may include identifying the errors or imperfections within the environment which allowed the security breach to occur. In at least some embodiments, identifying (220) system weaknesses includes analyzing components which correspond to the identified vulnerabilities to identify one or more errors which may contribute to the vulnerability. In one embodiment, identifying (220) system weaknesses includes utilizing a vulnerability score report to trace the vulnerability back to the weakness to which it corresponds.

Analyzing (230) historical data to identify similar past vulnerabilities may include accessing a set of historical data through which system vulnerability information is available for analysis. The historical data may correspond to logs for the subject system or environment, as well as available historical data for similar systems or environments which may share similar vulnerability characteristics. One example of an appropriate analysis method for analyzing historical data is described with respect to FIG. 3.

Analyzing (240) public information to extract one or more impacts of the identified similar past vulnerabilities may include identifying, within a set of publicly available information regarding similar systems, one or more consequences of the identified similar past vulnerabilities. For example, consider an example in which records indicate a system vulnerability was exposed at hour 0, and the system was subsequently immediately offline until hour 27. In such a case, the extracted impact of the identified similar past vulnerability would be that the system was shut down for 27 hours. Depending on the information available, one may be able to additionally discern whether the shutdown was directly caused by the vulnerability itself, in which case the impact would be classified as an unplanned shutdown, or whether the shutdown was required while the actual impact of the vulnerability breach was addressed. Consider an example in which a cyber attack leverages a vulnerability to expose details of transactions through a system; while the cyber attack itself did not directly cause an uncontrolled shutdown, the operator(s) may deem it safest to shut the system down until the vulnerability is addressed to keep additional transactions from being exposed. In such instances, the cyber attack's direct impact would be the exposure of transactional details, but the additional impact of a preventative shutdown may additionally be considered. In at least some embodiments, the impacts may be differentiated into categories such as industry impact, monetary impact, casualty, data impact, and the like. One example method for dataset categorization is described with respect to FIG. 4.

Determining (250) one or more impacts to the present system environment that would correspond to the extracted one or more impacts of the identified similar past vulnerabilities may include identifying one or more impacts within the present computing environment which could be considered parallel to the observed impacts of the identified similar past vulnerabilities. For example, if in a historical comparison, a certain type of data was compromised and leaked, determining (250) one or more impacts to the present system environment may include determining which data or data types correlate most closely to said leaked data. In at least some embodiments, determining (250) one or more impacts to the present system environment additionally includes translating impacts into a reader-digestible format to be presented to a user. For example, translating the impacts may include leveraging natural language generation applications that contain data-to-text systems configured to generate textual summaries of datasets. Translating the impacts may additionally include training a machine learning algorithm on a large set of input data and corresponding manually written output texts. The trained systems may be capable of text structuring (determining in which order information is presented in the text), sentence aggregation (deciding which information to present in individual sentences), lexicalization (finding the right words and phrases to express information), referring expression generation (selecting words and phrases to identify domain objects), and linguistic realization (combining all words and phrases into well-formed sentences).

Recommending (260) actions to remediate the vulnerabilities may include identifying one or more actions which, when taken, would either remove the existence of the vulnerabilities, or effectively defend against the determined impacts to the present system environment. In at least some embodiments, such as those wherein the vulnerabilities are associated with one or more common weaknesses, the recommended actions may be identified or selected from an available set of known potential mitigations corresponding to said known vulnerabilities.

FIG. 3 is a flowchart depicting a vulnerability correlation method 300 in accordance with at least one embodiment of the present invention. As depicted, vulnerability correlation method 300 includes extracting (310) an existing weakness corresponding to a target vulnerability, identifying (320) a set of vulnerabilities corresponding to the same weakness, selecting (330) one or more relevant vulnerabilities based on similarity constraints, filtering (340) the selected relevant vulnerabilities based on similarity of descriptions, and generating (350) key indicators and clauses corresponding to the vulnerabilities for result extraction.

Extracting (310) an existing weakness corresponding to a target vulnerability may include identifying errors or imperfections within system hardware or software which may correspond to a target vulnerability. For example, extracting (310) an existing weakness corresponding to a target vulnerability may include identifying the errors or imperfections within the environment which allowed a past security breach to occur. In at least some embodiments, extracting (310) an existing weakness includes analyzing components which correspond to the target vulnerability to identify one or more errors which may contribute to the vulnerability. In one embodiment, extracting (310) an existing weakness includes utilizing a vulnerability score report to trace the vulnerability back to the weakness to which it corresponds.

Identifying (320) a set of vulnerabilities corresponding to the same weakness may include analyzing or searching available data regarding known vulnerabilities to identify vulnerabilities which are caused by, or related to, the extracted existing weakness.

Selecting (330) one or more relevant vulnerabilities based on similarity constraints may include analyzing the identified set of vulnerabilities according to a set of one or more selected similarity constraints. Similarity constraints may include a time bound; for example, a vulnerability may not be considered relevant if its occurrence was recorded a relatively long time ago. In some embodiments, similarity constraints include a risk score; for example, a risk score relative to a vulnerability may be an indication of how likely a vulnerability is to be exploited, or a statistical reflection of how often a system exhibiting such a vulnerability is breached.

Filtering (340) the selected relevant vulnerabilities based on similarity of descriptions may include identifying or generating data descriptions of the selected relevant vulnerabilities and comparing them to a generated data description corresponding to the target vulnerability. The data descriptions may be generated according to the techniques described with respect to step 250 of vulnerability management method 200, described with respect to FIG. 2. In at least some embodiments, the similarity between a selected revenant vulnerability's description and the target vulnerability's description may be determined according to cosine similarity.

Generating (350) key indicators and clauses corresponding to the vulnerabilities for result extraction may include performing an internet search to identify documents relevant to the vulnerabilities. In at least some embodiments, generating (350) key indicates and clauses includes launching a web crawl to identify relevant documents. Generating (350) key indicators and clauses may additionally include executing a topic discovery algorithm to identify common terms that describe the impact of vulnerabilities. For example, a Latent Dirichlet Allocation may be appropriate for generating key indicators and clauses corresponding to vulnerability impacts. Generating (350) key indicators and clauses may further include executing a fuzzy match to identify slight variations of the identified keywords; in other words, the results from the topic discovery algorithm (such as a Latent Dirichlet Allocation) may be utilized as a starting point for a fuzzy match execution to identify various slight variations.

FIGS. 4A-4C depict one node patterns corresponding to results exhibiting contextual relevance between vulnerabilities and real world evidences. FIG. 4A depicts a node pattern corresponding to one or more characteristics of a target vulnerability. FIG. 4B depicts a set of web crawl results resultant from a web crawl for articles related to the node pattern. With respect to FIG. 4C, a series of nodes within the set of web crawl results are identified as a fuzzy match to the initial target vulnerability (nodes depicted with lined fill). With respect to the depicted embodiment, the identified fuzzy match may provide impact analysis information.

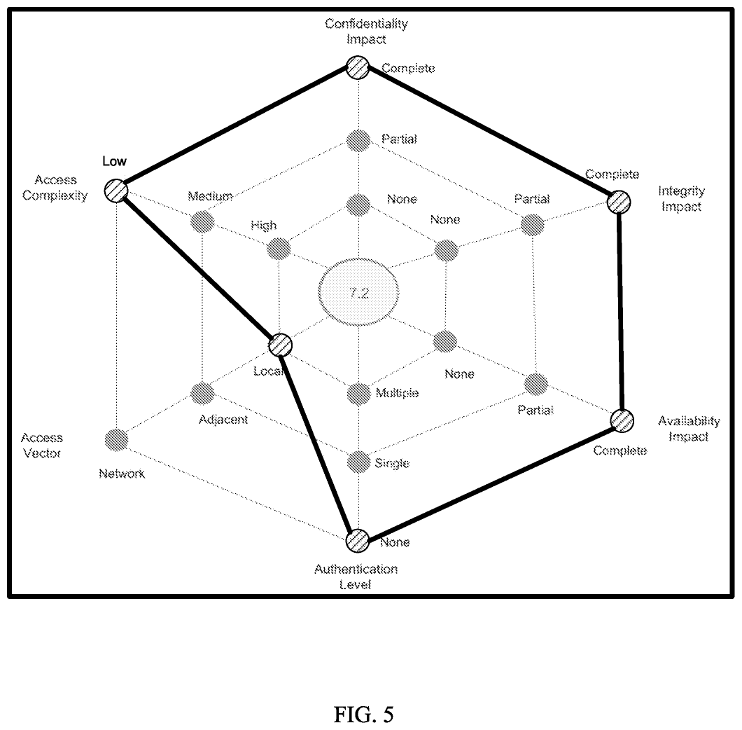

FIG. 5 depicts a vulnerability score breakdown in accordance with one embodiment of the present invention. As depicted, the diagram analyzes six aspects of a target's vulnerability: access complexity, an access level granted, authentication level, availability impact, integrity impact, and confidentiality impact. Access complexity describes how difficult it is to access the target; with respect to the depicted example, the target is granted a low access complexity, meaning the access conditions may not be specialized, and it may be simple to exploit. The access vector indicates what level of access has been breached or made available via the target; with respect to the depicted example, only the local level was accessed or available. The authentication level indicates what level of authentication is required to exploit the target; with respect to the depicted example, no authentication was required to exploit the vulnerability. The availability impact indicates how exploiting the vulnerability would affect the availability of the target; with respect to the depicted example, exploiting the vulnerability leads to a complete availability shutdown. The integrity impact indicates to what extent the target's integrity is compromised; with respect to the depicted example, exploiting the vulnerability leads to a complete compromise of system integrity, which may correspond to a complete loss of system protection. The confidentiality impact indicates what level of information is disclosed; with respect to the depicted example, there is total information disclosure, resulting in all system files being revealed.

FIG. 6 depicts a block diagram of components of computing system 110 in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

As depicted, the computer 600 includes communications fabric 602, which provides communications between computer processor(s) 604, memory 606, persistent storage 608, communications unit 612, and input/output (I/O) interface(s) 614. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 606 and persistent storage 608 are computer-readable storage media. In this embodiment, memory 606 includes random access memory (RAM) 616 and cache memory 618. In general, memory 606 can include any suitable volatile or non-volatile computer-readable storage media.

One or more programs may be stored in persistent storage 608 for access and/or execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 612, in these examples, provides for communications with other data processing systems or devices. In these examples, communications unit 612 includes one or more network interface cards. Communications unit 612 may provide communications through the use of either or both physical and wireless communications links.

I/O interface(s) 614 allows for input and output of data with other devices that may be connected to computer 600. For example, I/O interface 614 may provide a connection to external devices 620 such as a keyboard, keypad, a touch screen, and/or some other suitable input device. External devices 620 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 608 via I/0 interface(s) 614. I/O interface(s) 614 also connect to a display 622.

Display 622 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for managing vulnerability in a computing environment, the computer implemented method comprising:
analyzing a system environment to uncover one or more vulnerabilities;
identifying one or more system weaknesses corresponding to the one or more uncovered vulnerabilities;
analyzing a set of historical data to identify similar past vulnerabilities;
analyzing available information to extract one or more impacts of the identified similar past vulnerabilities;
determining one or more impacts to the computing environment that would correspond to the extracted one or more impacts of the identified similar past vulnerabilities; and
recommending one or more actions to remediate the uncovered vulnerabilities.

2. The computer implemented method of claim 1, wherein analyzing a system to uncover one or more vulnerabilities includes executing a security check to identify one or more system vulnerabilities.

3. The computer implemented method of claim 1, wherein analyzing the set of historical data to identify similar past vulnerabilities further includes filtering the similar past vulnerabilities based on one or more similarity constraints.

4. The computer implemented method of claim 3, wherein the one or more similarity constraints include a time constraint.

5. The computer implemented method of claim 3, wherein the one or more similarity constraints include a risk constraint, wherein the risk constraint indicates how likely a vulnerability is to be exploited.

6. The computer implemented method of claim 1, further comprising generating textual descriptions of the extracted one or more impacts.

7. The computer implemented method of claim 6, further comprising providing the generated textual descriptions of the extracted one or more impacts to a user.

8. A computer program product for managing vulnerability in a computing environment, the computer program product comprising:
one or more computer readable storage media and program instructions stored on the one or more computer readable storage media, the program instructions comprising instructions to:
analyze a system environment to uncover one or more vulnerabilities;
identify one or more system weaknesses corresponding to the one or more uncovered vulnerabilities;
analyze a set of historical data to identify similar past vulnerabilities;
analyze available information to extract one or more impacts of the identified similar past vulnerabilities;
determine one or more impacts to the computing environment that would correspond to the extracted one or more impacts of the identified similar past vulnerabilities; and
recommend one or more actions to remediate the uncovered vulnerabilities.

9. The computer program product of claim 8, wherein instructions to analyze a system to uncover one or more vulnerabilities include instructions to execute a security check to identify one or more system vulnerabilities.

10. The computer program product of claim 8, wherein instructions to analyze the set of historical data to identify similar past vulnerabilities further comprise instructions to filter the similar past vulnerabilities based on one or more similarity constraints.

11. The computer program product of claim 10, wherein the one or more similarity constraints include a time constraint.

12. The computer program product of claim 8, wherein the one or more similarity constraints include a risk constraint, wherein the risk constraint indicates how likely a vulnerability is to be exploited.

13. The computer program product of claim 8, further comprising instructions to generate textual descriptions of the extracted one or more impacts.

14. The computer program product of claim 13, further comprising instructions to provide the generated textual descriptions of the extracted one or more impacts to a user.

15. A computer system for managing vulnerability in a computing environment, the computer system comprising:
one or more computer processors;
one or more computer-readable storage media;
program instructions stored on the computer-readable storage media for execution by at least one of the one or more processors, the program instructions comprising instructions to:
analyze a system environment to uncover one or more vulnerabilities;
identify one or more system weaknesses corresponding to the one or more uncovered vulnerabilities;
analyze a set of historical data to identify similar past vulnerabilities;
analyze available information to extract one or more impacts of the identified similar past vulnerabilities;
determine one or more impacts to the computing environment that would correspond to the extracted one or more impacts of the identified similar past vulnerabilities; and
recommend one or more actions to remediate the uncovered vulnerabilities.

16. The computer system of claim 15, wherein instructions to analyze a system to uncover one or more vulnerabilities include instructions to execute a security check to identify one or more system vulnerabilities.

17. The computer system of claim 15, wherein instructions to analyze the set of historical data to identify similar past vulnerabilities further comprise instructions to filter the similar past vulnerabilities based on one or more similarity constraints.

18. The computer system of claim 17, wherein the one or more similarity constraints include a time constraint.

19. The computer system of claim 15, wherein the one or more similarity constraints include a risk constraint, wherein the risk constraint indicates how likely a vulnerability is to be exploited.

20. The computer system of claim 15, further comprising instructions to generate textual descriptions of the extracted one or more impacts.
